(19) United States
(12) Patent Application Publication
(10) Pub. No.: US 2023/0297345 A1
(43) Pub. Date: Sep. 21, 2023

(54) Distributed Asset Redemption

(71) Applicant: Disney Enterprises, Inc., Burbank, CA (US)

(72) Inventors: Alif Khalfan, Redwood City, CA (US); Daniel Fink, Brooklyn, NY (US)

(21) Appl. No.: 18/111,189

(22) Filed: Feb. 17, 2023

Related U.S. Application Data
(60) Provisional application No. 63/320,519, filed on Mar. 16, 2022.

(51) Int. Cl. G06F 8/36; G06Q 20/06

(52) U.S. Cl. CPC G06F 8/36; G06Q 20/065

(57) ABSTRACT

According to one implementation, a system includes a hardware processor and a memory storing software code. The hardware processor executes the software code to receive ownership data identifying a unique digital identifier conferring ownership, by a user, of an asset awarded by a first entity, confirm, using the unique digital identifier, ownership of the asset by the user, and verify, using the unique digital identifier, that a second entity is an authorized asset redemption partner of the first entity. The hardware processor further executes the software code to enable, using the unique digital identifier and in response to confirming and verifying, the user to redeem the asset awarded by the first entity from the second entity via transfer from a first digital wallet linked to the first entity to a second digital wallet linked to the second entity, either automatically or in response to an authentication performed by the user.

### RELATED APPLICATIONS

The present application claims the benefit of and priority to a pending U.S. Provisional Patent Application Ser. No. 63/320,519 filed on Mar. 16, 2022, and titled “Distributed NFT-Based Reward Redemption,” which is hereby incorporated fully by reference into the present application.

### BACKGROUND

The use of unique digital identifiers, such as the technology known as non-fungible token (NFTs) for example, allows individual artists and companies to sell ownership rights to a digital asset, such as a file containing a photo or other image, video, audio, or any other desirable digital representation of a real or virtual object. However, there is presently no mechanism by which a unique digital identifier generated by a first entity can be used directly to obtain an asset associated with that unique digital identifier from a second entity. That is to say, in the case of NFTs for example, an entitlement to an asset conferred by an NFT issued by one NFT source typically cannot be redeemed on an NFT platform of an entity other than that same NFT source. Instead, if a first entity wants to award an NFT based asset obtainable from a second entity, the first entity typically has to allow for an authorized NFT that features the asset conferred by the first entity to be minted by the second entity. As a result, the existing unique digital identifier-based transaction environment tends to undesirably limit consumer choice.

### BRIEF DESCRIPTION OF THE DRAWINGS

FIG. 1 shows a system for enabling distributed asset redemption, according to one exemplary implementation;

FIG. 2 shows a user device configured to mediate collection and redemption of one or more assets, according to one implementation; and

FIG. 3 shows a flowchart describing an exemplary method for enabling distributed asset redemption, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As stated above, the use of unique digital identifiers, such as the technology known as non-fungible tokens (NFTs) for example, allows individual artists and companies to sell ownership rights to a digital asset, such as a file containing a photo or other image, video, audio, or any other desirable digital representation of a real or virtual object. In addition, a unique digital identifier such as an NFT may be used to confer a unique entitlement to a redeemable asset. A unique digital identifier, of which an NFT is one example, is a unit of data stored on a secure digital ledger, such as a blockchain for example, that certifies a digital asset or entitlement to be unique and therefore non-fungible.

As also stated above, there is presently no mechanism by which a unique digital identifier generated by a first entity can be used directly to obtain an asset associated with that unique digital identifier from a second entity. That is to say, in the case of NFTs for example, an entitlement to an asset conferred by an NFT issued by one NFT source typically cannot be redeemed on an NFT platform of an entity other than that same NFT source. Instead, if a first entity wants to award an NFT based asset obtainable from a second entity, the first entity typically has to allow for an authorized NFT that features the asset conferred by the first entity to be minted by the second entity. As a result, the existing unique digital identifier-based transaction environment tends to undesirably limit consumer choice.

The present application discloses systems and method for enabling distributed asset redemption. The novel and inventive concepts disclosed in the present application introduce a unique digital identifier-based asset redemption system in which a particular user's unique digital identifier-based assets can be redeemed, whether those assets were awarded by the entity providing the unique digital identifier-based assets, or by another independent entity. The present unique digital identifier-based asset redemption solution encourages collaboration amongst unique digital identifier-based asset issuers, thereby advantageously expanding asset redemption opportunities for users patronizing different entities. Moreover, in some implementations, the present unique digital identifier-based asset redemption solution may be implemented as substantially automated systems and methods.

It is noted that, as used in the present application, the terms “automation,” “automated,” and “automating” refer to systems and processes that do not require the participation of a human user, such as a human editor or system administrator. Although, in some implementations, a human system administrator may review the performance of the automated systems operating according to the automated processes described herein, that human involvement is optional. Thus, the processes described in the present application may be performed under the control of hardware processing components of the disclosed systems.

It is further noted that, as defined in the present application, the term “unique digital identifier-based asset” may refer to any entitlement having its ownership certified by a unique digital identifier, such as an NFT for instance. By way of example, a unique digital identifier-based asset may include an entitlement to consume media content (i.e., content title), such as a movie, television show, book, music, or video game content. In some examples, the unique digital identifier-based asset may include an entitlement to access the media content prior to its availability to the general public, may include an entitlement to access a limited edition of the media content, may include an entitlement to access supplemental content related to the media content, or a combination thereof. Alternatively, or in addition, a unique digital identifier-based asset may include an entitlement to experience media content that may be or include digital representations of persons, fictional characters, locations, objects, and identifiers such as brands and logos, for example, which populate a virtual reality (VR), augmented reality (AR), or mixed reality (MR) environment. Moreover, that content may depict virtual worlds that can be experienced by any number of users synchronously and persistently, while providing continuity of data such as personal identity, user history, entitlements, possessions, payments, and the like. It is also noted that the distributed asset redemption solution disclosed by the present application may also apply to media content that is a hybrid of traditional audio-video and fully immersive VR/AR/MR experiences, such as interactive video.

As other examples, a unique digital identifier-based asset may include an entitlement to obtain a privilege, such as an access pass to an event or location, or an entitlement to obtain a digital file or physical object symbolic of a creative work. Thus, in various use cases unique digital identifier-based assets may also include digital assets, physical assets, real-world experiences, or AR, VR, or MR experiences.

The term “digital wallet” may refer to any secure software application assigned to an owner of a unique digital identifier-based asset that stores the unique digital identifier credentials (e.g., public and private keys, certifying ownership of the unique digital identifier-based asset), and enables the transfer of the unique digital identifier-based asset to another digital wallet. Furthermore, the relationship between a unique digital identifier-based asset and a digital wallet is many-to-one rather than one-to-one. That is to say, in some implementations, the same digital wallet may store credentials for each of multiple unique digital identifier-based assets. However, the credentials of a unique digital identifier-based asset are uniquely present in only one digital wallet at a time.

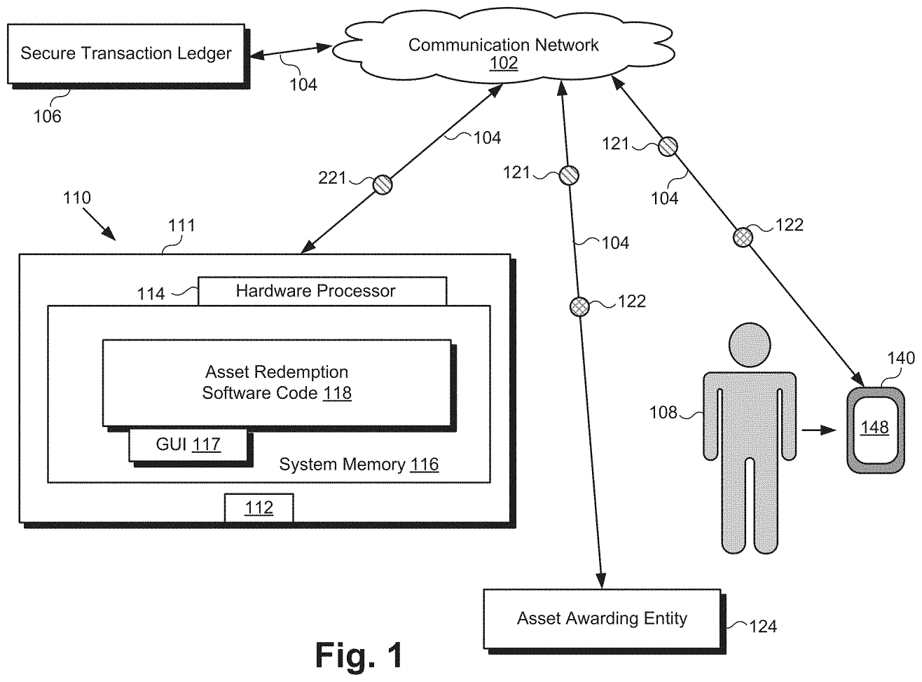

FIG. 1 shows system 110 for enabling distributed asset redemption, according to one exemplary implementation. As shown in FIG. 1, system 110 includes computing platform 111 having transceiver 112, hardware processor 114, and system memory 116 implemented as a computer-readable non-transitory storage medium. According to the present exemplary implementation, system memory 116 stores asset redemption software code 118 providing graphical user interface (GUI) 117. In addition, FIG. 1 shows asset awarding entity 124, user 108, who may be awarded unique digital identifier-based assets from asset awarding entity 124, user device 140 having display 148, and secure transaction ledger 106. Also shown in FIG. 1 are communication network 102 and network communication links 104 communicatively coupling system 110, asset awarding entity 124, and secure transaction ledger 106 to user device 140, as well as ownership data 121, one or more unique digital identifiers 122 (hereinafter “unique digital identifier(s) 122”) acquired by user 108 from asset awarding entity 124.

Regarding the expression “entity,” it is noted that as used in the present application the term “entity” may refer to a business organization, an individual human being, or a group of individual human beings acting collectively. Moreover, as used hereinafter in the present application the expression “first entity” refers to asset awarding entity 124, while the expression “second entity” may refer interchangeably to system 110 or to a third-party entity other than system 110 and asset awarding entity 124. In some implementations in which the first entity and the second entity are business organizations, the first entity and the second entity may be owned in common by a parent business entity. However, in other implementations in which the first entity and the second entity are business organizations, the first entity and the second entity may be independent business entities (i.e., no common ownership).

With respect to the representation of system 110 shown in FIG. 1, it is noted that although asset redemption software code 118 is depicted as being stored in system memory 116 for conceptual clarity, more generally, system memory 116 may take the form of any computer-readable non-transitory storage medium. The expression “computer-readable non-transitory storage medium,” as used in the present application, refers to any medium, excluding a carrier wave or other transitory signal that provides instructions to a hardware processor of a computing platform, such as hardware processor 114 of computing platform 111. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs, RAM, programmable read-only memory (PROM), erasable PROM (EPROM), and FLASH memory.

It is further noted that although FIG. 1 depicts asset redemption software code 118 as being entirely located in a single instance of system memory 116, that representation is also merely provided as an aid to conceptual clarity. More generally, system 110 may include one or more computing platforms, such as computer servers for example, which may be co-located, or may form an interactively linked but distributed system, such as a cloud-based system, for instance. As a result, hardware processor 114 and system memory 116 may correspond to distributed processor and memory resources of system 110. Thus, it is to be understood that various software modules of asset redemption software code 118 may be stored remotely from one another within the distributed memory resources of system 110.

Hardware processor 114 may include multiple hardware processing units, such as one or more central processing units, one or more graphics processing units, one or more tensor processing units, one or more field-programmable gate arrays (FPGAs), and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 111, as well as a Control Unit (CU) for retrieving programs, such as asset redemption software code 118, from system memory 116, while a GPU may be implemented to reduce the processing overhead of the CPU by performing computationally intensive graphics or other processing tasks. A TPU is an application-specific integrated circuit (ASIC) configured specifically for artificial intelligence (AI) applications such as machine learning modeling.

In some implementations, computing platform 111 may correspond to one or more web servers, accessible over a packet-switched network such as the Internet, for example. Alternatively, computing platform 111 may correspond to one or more computer servers supporting a private wide area network (WAN), local area network (LAN), or included in another type of limited distribution or private network. In addition, or alternatively, in some implementations, system 110 may utilize a local area broadcast method, such as User Datagram Protocol (UDP) or Bluetooth, for instance. Furthermore, in some implementations, system 110 may be implemented virtually, such as in a data center. For example, in some implementations, system 110 may be implemented in software, or as virtual machines. Moreover, in some implementations, communication network 102 may be a high-speed network suitable for high performance computing (HPC), for example a 10 GigE network or an Infiniband network.

Transceiver 112 may be implemented as a wireless communication unit configured for use with one or more of a variety of wireless communication protocols. For example, transceiver 112 may be configured for communications using one or more of a fourth generation wireless systems (4G) technology network utilizing a Long-Term Evolution (LTE) standard, or a fifth generation wireless systems (5G) technology network, for example. In addition, or alternatively, transceiver 112 may be configured for communications using one or more of WiFi, Bluetooth, Bluetooth LE, ZigBee, and 60 GHz wireless communications methods.

System 110 and asset awarding entity 124 may be creators of unique digital identifiers, such as “minters” of NFTs for example, creators and warehouses of unique digital identifiers, or distributors or warehouses of unique digital identifiers created by others. Secure transaction ledger 106 may take the form of a public or private secure transaction ledger. Examples of such secure transaction ledgers may include Blockchain, Hashgraph, Directed Acyclic Graph (DAG), and Holochain ledgers, to name a few. In use cases in which secure transaction ledger 106 is a blockchain ledger, it may be advantageous or desirable to implement secure transaction ledger 106 to utilize a consensus mechanism having a proof-of-stake (PoS) protocol, rather than the more energy intensive proof-of-work (PoW) protocol. Although secure transaction ledger 106 is shown to be remote from system 110 in FIG. 1, such as a cloud-based or distributed secure transaction ledger, that implementation is merely exemplary. In other implementations, secure transaction ledger 106 may be stored in system memory 116 and may be controlled by system 110.

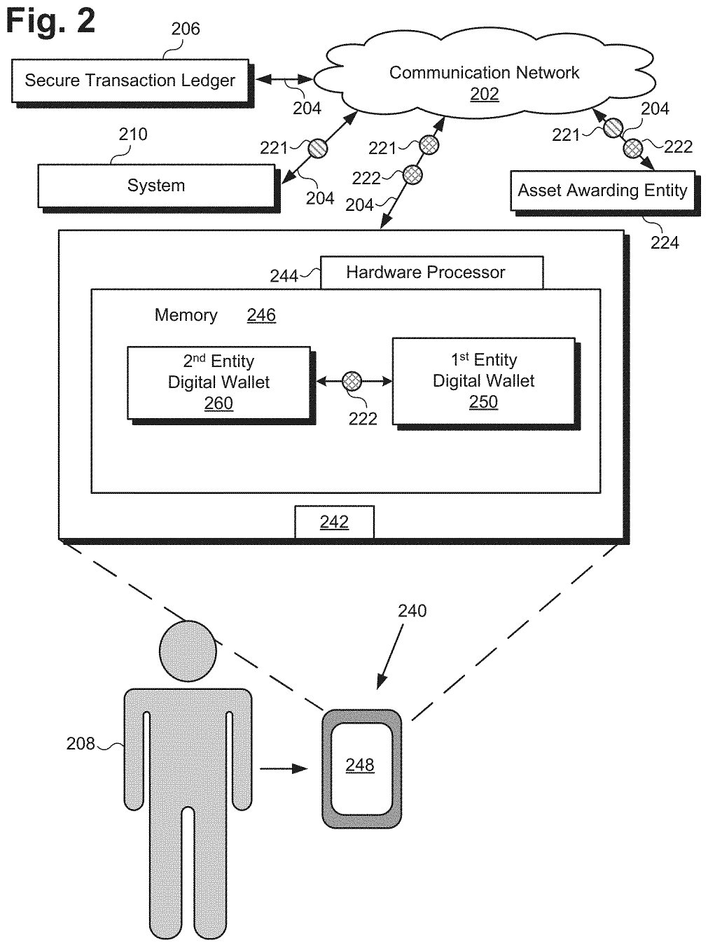

FIG. 2 shows user device 240 of user 208, configured to mediate collection and redemption of one or more unique digital identifiers 222 (hereinafter “unique digital identifier(s) 222”), according to one implementation. As shown in FIG. 2, user device 240 includes transceiver 242, hardware processor 244, display 248, and memory 246 implemented as a computer-readable non-transitory storage medium storing first entity digital wallet 250 and second entity digital wallet 260. Also shown in FIG. 2 are system 210, asset awarding entity 224, ownership data 221, communication network 202, network communication links 204, and secure transaction ledger 206.

Although user device 240 is shown as a smartphone in FIG. 1 that representation is provided merely as an example. More generally, user device 240 may be any suitable mobile or stationary computing device or system that implements data processing capabilities sufficient to provide a user interface, support connections to communication network 202, and implement the functionality ascribed to user device 240 herein. By way of non-limiting example, in other implementations, user device 240 may take the form of a desktop computer, laptop computer, tablet computer, smart TV, a smart wearable device, such as a smartwatch for example, or an AR or VR device.

Transceiver 242 may be implemented as a wireless communication unit configured for use with one or more of a variety of wireless communication protocols. For example, transceiver 242 may be configured for communications using one or more of a 4G technology network utilizing an LTE standard, or a 5G technology network. In addition, or alternatively, transceiver 242 may be configured for communications using one or more of WiFi, Bluetooth, Bluetooth LE, ZigBee, and 60 GHz wireless communications methods.

With respect to display 248 of user device 240, display 248 may be physically integrated with user device 240 or may be communicatively coupled to but physically separate from user device 240. For example, where user device 240 is implemented as a smartphone, laptop computer, or tablet computer, display 248 will typically be integrated with user device 240. By contrast, where user device 240 is implemented as a desktop computer, display 248 may take the form of a monitor separate from user device 240 in the form of a computer tower. Furthermore, display 248 of user device 240 may be implemented as a liquid crystal display (LCD), a light-emitting diode (LED) display, an organic light-emitting diode (OLED) display, a quantum dot (QD) display, or any other suitable display screen that performs a physical transformation of signals to light.

According to the exemplary implementation shown in FIG. 2, first entity digital wallet 250, when executed by hardware processor 244, can store unique digital identifier(s) issued by asset awarding entity 224 on user device 240, while second entity digital wallet 260, when executed by hardware processor 244, can store unique digital identifier(s) issued by system 210, or alternatively issued by another issuing entity of unique digital identifiers, on user device 240. However, in other implementations, one or more of first entity digital wallet 250 and second entity digital wallet 260 may not be resident on user device 240, but may be a virtual wallet remote from user device 240, such as a cloud-based virtual wallet accessible to user device 240 via communication network 202 and network communication links 204. In yet other implementations, one or more of first entity digital wallet 250 and first-party digital wallet may be a hardware cryptocurrency wallet, such as a Ledger Nano S® device or the like.

It is noted that, in addition to storing unique digital identifier(s), first entity digital wallet 250 may store user account information for a user account of user 108/208 with asset awarding entity 124/224 (hereinafter “first entity user account”). Analogously, second entity digital wallet 260 may store user account information for a separate user account of user 108/208 with system 110/210, or a separate user account of user 108/208 with another issuing entity of unique digital identifiers (in either case hereinafter “second entity user account”).

System 210, asset awarding entity 224, ownership data 221, unique digital identifier(s) 222, communication network 202, network communication links 204, and secure transaction ledger 206 correspond respectively in general to system 110, asset awarding entity 124, ownership data 121, unique digital identifier(s) 122, communication network 102, network communication links 104, and secure transaction ledger 106, in FIG. 1. Thus, system 210, asset awarding entity 224, ownership data 221, unique digital identifier(s) 222, communication network 202, network communication links 204, and secure transaction ledger 206 may share any of the characteristics attributed to respective system 110, asset awarding entity 124, ownership data 121, unique digital identifier(s) 122, communication network 102, network communication links 104, and secure transaction ledger 106 by the present disclosure, and vice versa.

Moreover, user 208 and user device 240, in FIG. 2, correspond respectively in general to user 108 and user device 140, in FIG. 1, and those corresponding features may share any of the characteristics attributed to either corresponding feature by the present disclosure. That is to say, although not shown in FIG. 1, in addition to display 148, user device 140 may include features corresponding respectively to transceiver 242, hardware processor 244, and memory 246 storing first entity digital wallet 250 and second entity digital wallet 260.

According to the exemplary implementation shown by FIGS. 1 and 2, user 108/208 receives unique digital identifier(s) 122/222 issued by asset awarding entity 124/224. Unique digital identifier(s) 122/222, which, despite being issued by asset awarding entity 124/224, may confer ownership of entitlement(s) to unique digital identifier-based assets that are only accessible via system 110/210. That is to say, asset awarding entity 124/224 may issue unique digital identifier(s) 122/222 for assets that can only be redeemed from system 110/210. The issuance of unique digital identifier(s) 122/222 by asset awarding entity 124/224 may result in generation of smart contracts governing the redemption terms for each of the asset identified by unique digital identifier(s) 122/222. In some implementations, such smart contracts may be generated by asset awarding entity 124/224. However, in other implementations, those smart contracts may be generated by asset redemption software code 118, in FIG. 1, executed by hardware processor 114 of system 110/210. Once unique digital identifier(s) 122/222 has/have been issued to user 108/208 and the smart contracts governing redemption of their respectively associated unique digital identifier-based asset(s) have been generated, unique digital identifier(s) may be uniquely stored in first entity digital wallet 250, and the transfer of ownership of the unique digital identifier-based assets to user 108/208, as well as the terms of their respective smart contracts, are recorded on secure transaction ledger 106/206.

The information identifying system 110/210, asset awarding entity 124/224, user 108/208, and the terms of the smart contracts for the asset(s) identified by unique digital identifier(s) 122/222 may be obtained from secure transaction ledger 106/206 in FIGS. 1 and 2. In some implementations, hardware processor 114 of system 110/210 may execute asset redemption software code 118 to search transaction ledger 106/206 for all data necessary to redeem the assets associated with unique digital identifier(s) 122/222.

In some implementations, unique digital identifier(s) 122/222 may each be wrapped or signed with metadata describing the terms of their respective smart contracts. It is noted that, as used in the present application, the terms “wrapped” and “wrapping” refer to the storing of metadata for unique digital identifier with the unique digital identifier itself. Thus, in some implementations, the information identifying system 110/210, asset awarding entity 124/224, user 108/208, and the terms of the smart contracts for the asset(s) identified by unique digital identifier(s) 122/222 may be obtained from each unique digital identifier itself, rather than having to be obtained from secure transaction ledger 106/206 in FIGS. 1 and 2. Because searching secure transaction ledger 106/206 in FIGS. 1 and 2 for metadata describing the terms of smart contracts can be a time consuming and computationally expensive process, storing such metadata with the unique digital identifier itself advantageously increases the speed with which asset redemptions may be completed, while significantly reducing computational overhead.

In some use cases, a unique digital identifier-based asset may be completely determined at the time of its awarding. However, in other use cases a unique digital identifier-based asset may be dynamic, and may change, or have its valued increased or decreased, due to time lapse between awarding and redemption, or in response to an action taken by user 108/208 subsequent to unique digital identifier issuance but before asset redemption. Moreover, in some use cases, redemption of a unique digital identifier-based asset may require user 108/208 to have acquired multiple unique digital identifiers prior to redemption.

In some implementations, as shown in FIG. 2, first entity digital wallet 250 and second entity digital wallet 260 may communicate so as to share user account information, or to transfer unique digital identifier(s) 122/222 from one digital wallet to another. For example, unique digital identifier(s) 122/222 issued by asset awarding entity 124/224 may initially be stored in first entity digital wallet 250, but may be transferred to second entity digital wallet 260.

In yet other use cases, asset redemption may be read-only or bidirectional, and may require transfer of a unique digital identifier issued by asset awarding entity 124/224 from first entity digital wallet 250 to second entity digital wallet 260, as well as transfer of a unique digital identifier issued by system 110/210 from second entity digital wallet 260 to first entity digital wallet 250. In some use cases, one or both of second entity digital wallet 260 and first entity digital wallet 250 may be configured to auto-recognize the unique digital identifier(s), and to alert user 108/208, via email or text for example, that assets associated with unique digital identifier(s) 122/222 are redeemable. That is to say the second entity user account of user 108/208 and the first entity user account of user 108/208 may be linked through respective second entity digital wallet 260 and first entity digital wallet 250 and may not require transferring of unique digital identifiers.

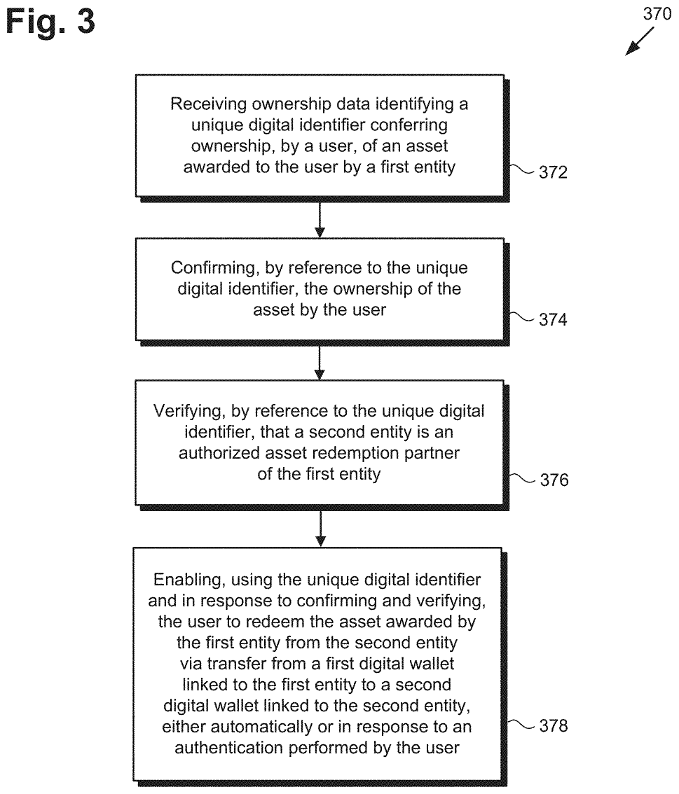

The functionality of system 110/210 will be further described below with reference to FIG. 3. FIG. 3 shows flowchart 370 presenting an exemplary method for enabling distributed asset redemption, according to one implementation. With respect to the method outlined by FIG. 3, it is noted that certain details and features have been left out of flowchart 370 in order not to obscure the discussion of the inventive features in the present application. It is further noted that the expressions “first entity 124/224” and “asset awarding entity 124/224” may be used interchangeably. Moreover, and in the interests of conceptual clarity with respect to the claims appended hereto, the expression “first entity 124/224” will be used in place of the expression “asset awarding entity 124/224” in the description of flowchart 370. Furthermore, and as noted above, in some use cases, the second entity referenced by flowchart 370 may be system 110/210. However, in other implementations, the second entity referenced in action 376 may be a third-party entity other than system 110/210 and asset awarding entity 124/224.

Referring to FIG. 3 with further reference to FIGS. 1 and 2, flowchart 370 includes receiving, by system 110/210, ownership data 121/221 identifying a unique digital identifier (i.e., one of unique digital identifier(s) 122/222) conferring ownership, by user 108/208, of an asset awarded to user 108/208 by first entity 124/224 (action 372). The asset awarded to user 108/218 by first entity 124/224 and having its ownership authenticated by a unique digital identifier is a unique digital identifier-based asset, as described above. Moreover. and as noted above, in some implementations, the unique digital identifier identified by ownership data 121/221 may be an NFT. By way of example, such a unique digital identifier-based asset may include an entitlement to consume media content (i.e., a content title), such as a movie, television show, book, music, or video game content. In some examples, the unique digital identifier-based asset may include an entitlement to access the media content prior to its availability to the general public, may include an entitlement to access a limited edition of the media content, may include an entitlement to access supplemental content related to the media content, or a combination thereof. Alternatively, or in addition, a unique digital identifier-based asset may include an entitlement to experience media content that may be or include digital representations of persons, fictional characters, locations, objects, and identifiers such as brands and logos, for example, which populate a VR, AR, or MR environment. Furthermore, that content may depict virtual worlds that can be experienced by any number of users synchronously and persistently, while providing continuity of data such as personal identity, user history, entitlements, possessions, payments, and the like. It is also noted that the distributed asset redemption solution disclosed by the present application may also apply to media content that is a hybrid of traditional audio-video and fully immersive VR/AR/MR experiences, such as interactive video.

As other examples, a unique digital identifier-based asset may include an entitlement to obtain a privilege, such as an access pass to an event or location, or an entitlement to obtain a digital file or physical object symbolic of a creative work. Thus, in various use cases unique digital identifier-based assets may also include digital assets, physical assets, real-world experiences, or AR, VR, or MR experiences, or an entitlement to access a content title such as a movie, television show, book, and musical single or album, for example, prior to its availability to the general public. Ownership data 121/221 may be received in action 372 by asset redemption software code 118 of system 110/210, executed by hardware processor 114 of computing platform 111. In some implementations, as shown in FIGS. 1 and 2, ownership data 121/221 may be received by system 110/210 from first entity 124/224, via communication network 102/202 and network communication links 104/204. However, in other implementations, as also shown in FIGS. 1 and 2, ownership data 121/221 may be received by system 110/210 from user device 140/240 of user 108/208, via communication network 102/202 and network communication links 104/204.

Continuing to refer to FIG. 3 in combination with FIGS. 1 and 2, flowchart 370 further includes confirming, by system 110/210 and using the unique digital identifier identified by ownership data 121/221, the ownership by user 108/208 of the asset also identified by ownership data 121/221 (action 374). In some implementations, confirmation of the ownership by user 108/208 of the asset identified by ownership data 121/221 may be performed using the unique digital identifier identified by ownership data 121/221 by reference to secure transaction ledger 106/206, such as a blockchain for example, as described above. Alternatively, in some implementations, confirmation of the ownership by user 108/208 of the asset identified by ownership data 121/221 may be performed by reference to metadata wrapping or otherwise accompanying the unique digital identifier, as also described above. Confirmation of the ownership by user 108/208 of the asset identified by ownership data 121/221, in action 374, may be performed by asset redemption software code 118 of system 110/210, executed by hardware processor 114 of computing platform 111.

Continuing to refer to FIG. 3 in combination with FIGS. 1 and 2, flowchart 370 further includes verifying, by system 110/210 and using the unique digital identifier identified by ownership data 121/221, that a second entity is an authorized asset redemption partner of first entity 124/224 (action 376). As noted above, in some use cases, the second entity referenced in action 376 may be system 110/210. However, in other implementations, the second entity referenced in action 376 may be a third-party entity other than system 110/210 and first entity 124/224.

In some implementations, verification that the second entity is an authorized asset redemption partner of the first entity 124/224 may be performed using the unique digital identifier identified by ownership data 121/221 by reference to a smart contract governing the redemption terms for the asset identified by the unique digital identifier, stored on secure transaction ledger 106/206, such as a blockchain for example, as described above. Alternatively, in some implementations, verification that the second entity is an authorized asset redemption partner of first entity 124/224 may be performed by reference to metadata wrapping or otherwise accompanying the unique digital identifier and including the smart contract governing the redemption terms for the asset identified by the unique digital identifier, as also described above. Verification that the second entity is an authorized asset redemption partner of first entity 124/224, in action 376, may be performed by asset redemption software code 118 of system 110/210, executed by hardware processor 114 of computing platform 111.

It is noted that although flowchart 370 depicts action 376 as following action 376, that representation is merely exemplary. In various other implementations, action 376 may precede action 374, or may be performed in parallel with, i.e., contemporaneously with, action 374.

Continuing to refer to FIG. 3 in combination with FIGS. 1 and 2, flowchart 370 further includes enabling, by system 110/210, using the unique digital identifier and in response to the confirmation and verification performed actions 374 and 376, user 108/208 to redeem the asset (awarded by first entity 124/224) from the second entity (action 378). Redemption of the asset from the second entity may occur via transfer from first entity digital wallet 250 linked to first entity 124/224 to second entity digital wallet 260 linked to the second entity, either automatically or in response to a user authentication. For example, in some implementations metadata accompanying the unique digital identifier or the smart contract governing redemption of the asset may specify that the unique digital identifier conferring ownership of the asset can be transferred between wallets. In those implementations, system 110/210 could access first entity digital wallet 250 of user 108/208 via some form of authentication performed by user 108/208. In other words, metadata accompanying the unique digital identifier issued by first entity 124/224 or the smart contract governing redemption of the asset may confirm that the unique digital identifier was issued by a particular entity, or may include an image depicting the asset having been awarded. In addition, in some implementations, the unique digital identifier may be wrapped in a smart contract or other metadata that allows for the transfer of that unique digital identifier across digital wallets automatically in order to redeem certain assets.

As noted above, in some use cases, the second entity referenced in actions 376 and 378 may be system 110/210. However, in other implementations, the second entity referenced in actions 376 and 378 may be a third-party entity other than 110/210 and first entity 124/224.

Thus, in some implementations in which ownership data 121/221 is received by system 110/210 from first entity 124/224 in action 372, transfer of the unique digital identifier identified by ownership data 121/221 from first entity digital wallet 250 linked to first entity 124/224 to second entity digital wallet 260 linked to the second entity may occur automatically in action 378. Moreover, in some implementations, as shown in FIG. 2, first entity digital wallet 250 linked to first entity 124/224 and second entity digital wallet 260 linked to the second entity may be stored on user device 140/240. Transfer of the unique digital identifier identified by ownership data 121/221 from first entity digital wallet 250 linked to first entity 124/224 to second entity digital wallet 260 linked to the second entity, in action 378, may be performed by asset redemption software code 118 of system 110/210, executed by hardware processor 114 of computing platform 111.

With respect to the method outlined by flowchart 370, it is noted that, in various implementations, actions 372, 374, 376, and 378, or actions 372, 376, 374, and 378, or actions 372, 374/376, and 378, may be performed in an automated process from which human involvement may be omitted.

As a merely illustrative example of the method outlined by flowchart 370 and described above, the following use case is presented in which the second entity described above is a media production and distribution company that produces feature films and hosts a streaming media service, while the first entity is a commodities retailer authorized by the second entity to participate in a cross-platform affinity asset redemption program with the second entity.

According to the present illustrative example, user 108/208 is a fan of a particular movie franchise (hereinafter “franchise A”) owned by the second entity. User 108/208 owns a digital wallet storing unique digital identifiers authenticated by the second entity owner of franchise A that user 108/208 has earned or acquired over time. Those unique digital identifiers owned by user 108/208 may include unique digital identifiers purchased on marketplaces, as well as unique digital identifiers user 108/208 has earned by watching content streamed by the second entity. One of the unique digital identifiers owned by user 108/208, grants user 108/208 the entitlement to view new franchise A content on the streaming service hosted by the second entity thirty days after the theatrical release window of the new franchise A content, in contrast to the standard sixty day waiting period.

However, a franchise A “all access” unique digital identifier-based asset exists, which user 108/208 does not yet own. That “all access” asset entitles its owner to view new franchise A content on the day and date of its theatrical release. First entity 124/224 seeking to create a new promotional opportunity for its products, wishes to partner with the second entity to offer its own commodities related unique digital identifiers that confer the same assets as the franchise A all access entitlement to new franchise A content. In order to enable this, system 110/210 receives ownership data 121/221 identifying a unique digital identifier conferring ownership of the all access asset to user 108/208, issued by first entity 124/224; authenticates that ownership by reference to secure transaction ledger 106/206 or metadata accompanying the unique digital identifier; and grants the same all access entitlement to new franchise A content streamed by the second entity as though that entitlement had been awarded to user 108/208 by the second entity itself, rather than by first entity 124/224.

That is to say, in some implementations, as noted above, a unique digital identifier-based asset may include an entitlement to access a content title. The unique digital identifier-based asset may include an entitlement to access the content title prior to its availability to the general public, may include an entitlement to access a limited edition of the content title, may include an entitlement to access supplemental content related to the content title, or a combination thereof. Such accessible content titles may include movies, television shows, books, and musical singles or albums, for example.

Thus, the present application discloses systems and methods for enabling distributed unique digital identifier-based asset redemption that address and overcome the deficiencies in the conventional art. From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor; and
a system memory storing a software code;
the hardware processor configured to execute the software code to:
receive ownership data identifying a unique digital identifier conferring ownership, by a user, of an asset awarded to the user by a first entity;
confirm, using the unique digital identifier, the ownership of the asset by the user;
verify, using the unique digital identifier, that a second entity is an authorized asset redemption partner of the first entity; and
enabling, using the unique digital identifier and in response to confirming and verifying, the user to redeem the asset awarded by the first entity from the second entity via transfer from a first digital wallet linked to the first entity to a second digital wallet linked to the second entity, either automatically or in response to an authentication performed by the user.

2. The system of claim 1, wherein the unique digital identifier comprises a non-fungible token (NFT).

3. The system of claim 1, wherein at least one of confirming the ownership of the asset by the user or verifying that the second entity is an authorized asset redemption partner of the first entity comprises referencing a blockchain.

4. The system of claim 1, wherein at least one of confirming the ownership of the asset by the user or verifying that the second entity is an authorized asset redemption partner of the first entity comprises referencing metadata accompanying the unique digital identifier.

5. The system of claim 1, wherein the ownership data is received from the first entity or from a user device of the user.

6. The system of claim 1, wherein the first digital wallet and the second digital wallet are stored on a user device of the user.

7. The system of claim 1, wherein the asset comprises a digital asset.

8. The system of claim 1, wherein the asset comprises an entitlement to one of a physical asset, a real-world experience, an augmented reality experience, a virtual reality experience, a mixed reality experience, or a content title.

9. The system of claim 1, wherein the first entity and the second entity are owned in common by a parent business entity.

10. The system of claim 1, wherein the first entity and the second entity are independent business entities.

11. A method for use by a system including a hardware processor and a system memory storing a software code, the method comprising:
receiving, by the software code executed by the hardware processor, ownership data identifying a unique digital identifier conferring ownership, by a user, of an asset awarded to the user by a first entity;
confirming, by the software code executed by the hardware processor and using the unique digital identifier, the ownership of the asset by the user;
verifying, by the software code executed by the hardware processor and using the unique digital identifier; that a second entity is an authorized asset redemption partner of the first entity; and
enabling, by the software code executed by the hardware processor, using the unique digital identifier and in response to confirming and verifying, the user to redeem the asset awarded by the first entity from the second entity via transfer from a first digital wallet linked to the first entity to a second digital wallet linked to the second entity, either automatically or in response to an authentication performed by the user.

12. The method of claim 11, wherein the unique digital identifier comprises a non-fungible token (NFT).

13. The method of claim 11, wherein at least one of confirming the ownership of the asset by the user or verifying that the second entity is an authorized asset redemption partner of the first entity comprises referencing a blockchain.

14. The method of claim 11, wherein at least one of confirming the ownership of the asset by the user or verifying that the second entity is an authorized asset redemption partner of the first entity comprises referencing metadata accompanying the unique digital identifier.

15. The method of claim 11, wherein the ownership data is received from the first entity or from a user device of the user.

16. The method of claim 11, wherein the first digital wallet and the second digital wallet are stored on a user device of the user.

17. The method of claim 11, wherein the asset comprises a digital asset.

18. The method of claim 11, wherein the asset comprises an entitlement to one of a physical asset, a real-world experience, an augmented reality experience, a virtual reality experience, a mixed reality experience, or a content title.

19. The method of claim 11, wherein the first entity and the second entity are owned in common by a parent business entity.

20. The method of claim 11, wherein the first entity and the second entity are independent business entities.
